(19) United States
(12) Patent Application Publication
(10) Pub. No.: US 2005/0204830 A1
(43) Pub. Date: Sep. 22, 2005

(54) Magnetostrictive torque sensor shaft and method for manufacturin the same

(76) Inventors: Akihiro Kuroda, Hamamatsu-shi (JP); Hiromitsu Kaneda, Hamamatsu-shi (JP); Yuichi Mizumura, Hamamatsu-shi (JP)

Correspondence Address: MYERS BIGEL SIBLEY & SAJOVEC, PO BOX 37428, RALEIGH, NC, 27627, US

(21) Appl. No.: 10/517,995

(22) PCT Filed: Apr. 23, 2003
(86) PCT No.: PCT/JP03/05166

§ 371 Date: Dec. 15, 2004

(30) Foreign Application Priority Data
Jul. 3, 2002 (JP) 2002-194391

(51) Int. Cl. G01L 3/02

(52) U.S. Cl. 73/862.331

(57) ABSTRACT

The present invention improves the magnetization shielding properties of a torque sensor shaft for a magnetostrictive torque sensor. Specifically, according to the present invention, a magnetostrictive torque sensor shaft 2 is provided with a magnetostrictive detection portion 5 and an engaging portion 6 for engaging a power transmission shaft, wherein the torque sensor shaft 2 includes a magnetostrictive material, and is provided with a paramagnetic layer, which contains retained austenite, at a surface of a range that includes at least the engaging portion 6, but excludes the magnetostrictive detection portion 5. Also a method for manufacturing the same is provided.

### TECHNICAL FIELD

The present invention relates to torque sensor shafts for magnetostrictive torque sensors that utilize the reverse magnetostriction effect and, in particular, to magnetostrictive torque sensor shafts in which midpoint output fluctuation is reduced.

### BACKGROUND ART

It is necessary to detect torque in order to properly control systems such as automobile transmissions, 4WD torque splitters, and electronic power steering (EPS) systems. For example, EPS is a power steering system in which an electronic motor is controlled in response to torque that is input to a steering wheel of an automobile or the like so that an assisting force is generated, and it is essential to detect the torque applied to the steering wheel in order to achieve that control. Conventionally, torque sensors, in particular, magnetostrictive torque sensors that have extremely high sensitivity in detecting strain and can detect extremely slight strain, are used to detect this torque. Japanese unexamined patent application publication JP H1-169983-A and Japanese examined patent application publication JP H8-31636-B teaches some examples of magnetostrictive torque sensors.

However, with such magnetostrictive torque sensor, it is unavoidable that engaging portions, which are positioned at the ends of the torque sensor shaft and are used for engaging to other power transmission shafts and conveying power, are exposed from the casing inside of which the torque detection portion is housed. That is, the torque detection portion on the torque sensor shaft can be inside the casing, which functions as a magnetic shield, but this is difficult to achieve for the engaging portions and the engaging portions are left open magnetically to external portions. For this reason there is the problem that the magnetic force lines inside the torque sensor are affected by external portions. In particular, when ferromagnetic materials such as structural steel (for example, carbon steel, chromium steel, nickel chromium steel, nickel chromium molybdenum steel, manganese steel, and manganese chromium steel) are used for the sensor shaft, the torque sensor is strongly affected by external portions, and the distribution of the magnetic force lines inside the torque sensor changes when the engaging portions approach a ferromagnetic material, or when the engaging portions engage to other power transmission shafts.

Generally, the midpoint of the torque sensor in the initial state is adjusted so that output is zero when the torque is zero. However, as described above, since conventionally the engaging portions of the torque sensor shaft are not shielded magnetically, there has been the problem that the distribution of the magnetic force lines inside the torque sensor changes when the torque sensor shaft is connected to other drive shafts, causing fluctuation in the midpoint of the torque sensor output.

### DISCLOSURE OF INVENTION

The present invention was arrived at in light of the above-described conditions, and it is an object thereof to provide a torque sensor shaft for a magnetostrictive torque sensor that is able to provide the additional merit of having a magnetically shielded torque sensor shaft without loss of torque detection accuracy or physical strength at a low price.

The present invention provides a magnetostrictive torque sensor shaft comprising a magnetostrictive detection portion and an engaging portion for engaging a power transmission shaft, wherein the torque sensor shaft comprises a magnetostrictive material, and comprises a paramagnetic layer having a content of retained austenite of at least 10 vol % at a surface of at least the engaging portion, but excluding the magnetostrictive detection portion. It should be noted that the content of retained austenite in the paramagnetic layer is preferably at least 50 vol %. It should also be noted that a thickness of the paramagnetic layer is preferably at least 300 μm. Furthermore, it is preferable that the torque sensor shaft contains a ferromagnetic material, and it is further preferable that the ferromagnetic material contains 3 to 30 wt % Ni.

Here, “magnetostrictive detection portion” refers to the position on the magnetostrictive torque sensor shaft at which a magnetic characteristic changes in response to torque. For example, as disclosed in Japanese Patent No. 169326-B, by arranging grooves tilted at 45° from the axial direction of the surface of a ferromagnetic material torque sensor shaft, the torque sensor shaft is given magnetic anisotropy due to the effect of that shape, and it is possible to detect magnetic change in such portions. Such portions are known as magnetostrictive detection portions. Alternatively, as disclosed in Japanese Patents No. 2710165-B and 2965628-B, it is possible to arrange magnetostrictive detection portions by adding a magnetostrictive layer to the surface of the torque sensor shaft. Or, as disclosed in unexamined patent application publication JP 2002-107240-A, it is possible to arrange magnetostrictive detection portions by performing a localized temperature treatment on a material whose magnetization changes in response to temperature change. However, while the magnetostrictive detection portion according to the present invention may include any of these, it is not limited to these examples.

Furthermore, “engaging portion” refers to the position on the magnetostrictive torque sensor shaft that is used for connecting other power transmission shafts to the torque sensor shaft. Examples of other power transmission shafts include steering shafts, propeller shafts, and drive shafts and the like, but there is no limitation to these. Furthermore, the engaging portion can be achieved by forming serrations on the torque sensor shaft, or by forming a polygonal profile shape. Alternatively, the engaging portion can be arranged by press fitting using an aperture and a shaft, or by bolt fastening arranged with a flange. However, while the engaging portion according to the present invention may include any of these, it is not limited to these examples.

Furthermore, “magnetostrictive material” refers to a metal that possesses a property by which its magnetic permeability changes when subjected to physical force. Alloys such as iron-aluminum based alloys, iron-nickel based alloys, and iron-cobalt based alloys may be used, but there is no limitation to these. Preferably, the magnetostrictive material is a ferromagnetic material. “Ferromagnetic material” refers to metals that have ferromagnetism, and metals such as carbon steel, chromium steel, nickel chromium steel, nickel chromium molybdenum steel, manganese steel, and manganese chromium steel may be used, but there is no limitation to these. Furthermore, “retained austenite” refers to the portion of austenite in quenched steel that remains as it is untransformed, and the content (vol %) of retained austenite can be measured by measuring the intensity of diffraction in the retained austenite phase using X-ray diffraction, or by observing a cross section of the steel with a microscope.

According to the present invention, the engaging portion of the magnetostrictive torque sensor shaft is covered with a paramagnetic layer that contains retained austenite, and is magnetically shielded, thus suppressing the effect of external portions on the magnetic force lines inside the torque sensor.

Furthermore, the present invention provides a magnetostrictive torque sensor comprising the magnetostrictive torque sensor shaft. By respectively combining an appropriate excitation means, a detection means, and a shield case, the torque sensor shaft can achieve an even more effective shield.

Moreover, the present invention provides a method for manufacturing a magnetostrictive torque sensor shaft.

Namely, the present invention, provides a method for manufacturing a magnetostrictive torque sensor shaft, the magnetostrictive torque sensor shaft comprising a magnetostrictive detection portion and an engaging portion for engaging another power transmission shaft, wherein a paramagnetic layer containing retained austenite is formed by a carburization treatment being performed on a surface of at least the engaging portion, but excluding the magnetostrictive detection portion. Preferably, the carbon potential in the carburization treatment is at least 0.8 wt %. Furthermore, it is preferable that prior to the carburization treatment an anti-carburization treatment is carried out on the magnetostrictive detection portion, and that after the carburization treatment an anti-carburization treated portion may be removed to expose a magnetostrictive material on a surface of the magnetostrictive detection portion.

Here, “carburization treatment” refers to a treatment in which carbon is diffused into the surface of a metal. In addition to solid carburizing (charcoal), gas carburizing, and liquid carburizing, other methods that can be used include vacuum carburizing (a method in which carburizing is performed using a vacuum furnace), plasma carburizing (also called ion carburizing), and drip method carburizing (in which a C—H—O based liquid organic agent is dripped into a furnace and thermally decomposed carbon is used), but there is no limitation to these. In particular, gas carburizing is generally used and is preferable. Furthermore, “carbon potential (CP)” is also called the amount of balanced carbon, and refers to the carburization capabilities of the atmosphere inside the furnace. For example, a carbon potential of 1.2% is defined as a state in which the concentration of carbon allows a carburization of up to 1.2%. Since the O₂ gas, CO gas, and carbon potential inside the furnace are maintained in a balanced state, it is possible to control the atmosphere inside the furnace by measuring the partial pressure of O₂. The higher the carbon potential, the more strongly carburizing can be performed.

Furthermore, “anti-carburization treatment” refers to a treatment that is carried out in advance on a material prior to a carburization treatment so that carburization does not occur to the material. In addition to a Cu plating treatment, Cr plating and Ni plating or the like may be used, but there is no limitation to these. Furthermore, “anti-carburization portion” refers to a layer provided on the surface of a magnetostrictive detection portion of a torque sensor shaft by the above-mentioned anti-carburization treatment.

It is possible to easily form a magnetization shield on the surface of at least the engaging portions of the torque sensor excluding the magnetostrictive detection portions by forming a paramagnetic layer containing retained austenite using a carburization treatment and, further still, this allows a degree of freedom for the material of the torque sensor shaft. In particular, when forming a paramagnetic layer by performing a carburization treatment on at least the engaging portions of a ferromagnetic torque sensor shaft excluding the magnetostrictive detection portions, since it is not necessary to add a new layer on the surface of the torque sensor shaft structure, it is possible to manufacture a torque sensor that can withstand excessive torque input.

Furthermore, by increasing the carbon potential, it is possible to promote the production of retained austenite and reduce the amount of expensive Ni used in the torque sensor shaft structure. Moreover, a paramagnetic layer can be formed on only the required positions by performing the carburization treatment after an anti-carburization treatment.

As is evident from the following description, a torque sensor shaft for a magnetostrictive torque sensor according to the present invention is able to provide the additional merit of having a magnetically shielded torque sensor shaft without loss of torque detection accuracy or physical strength at a low price.

In other words, it is possible to suppress midpoint fluctuation by forming an austenite layer, which has an effect of shielding from magnetism, by a carburization treatment at engaging portions that engage with a power transmission shaft, such that midpoint adjustments can be eliminated and detection sensitivity can be increased. Furthermore, since it is possible to form in desired positions an austenite layer that has a magnetization shielding effect by heat treatment, it is possible to use structural steel for the sensor shaft, which provides stable detection sensitivity, which is related to causes of hysteresis and non-linearity, and which has superior overload characteristics with regard to rated torque. Furthermore, by forming with heat treatment an austenite layer, which has a magnetization shielding effect, in only necessary positions, it is unnecessary to use austenite based alloys that contain a lot of expensive Cr and Ni, and therefore it is possible to provide a low-cost, high-performance torque sensor.

### BRIEF DESCRIPTION OF DRAWINGS

FIG. 1 is a schematic diagram of a magnetostrictive torque sensor according to the present invention.

FIG. 2 is a schematic diagram of a torque sensor shaft according to the present invention.

FIG. 3 is a schematic cross section at an engaging portion of a torque sensor shaft according to the present invention.

FIG. 4 is a graph showing the relation between the amount of retained austenite and midpoint fluctuation.

FIG. 5 is a graph showing the relation between the content of C in an Fe—C based alloy and the amount of retained austenite produced.

FIG. 6 is a graph showing the relation between the amount of contained Ni and the content of C in an Fe—C—Ni based alloy and the amount of retained austenite produced.

FIG. 7 is a schematic drawing of carburization-treatment conditions according to the present invention.

### DEATILED DESCRIPTION OF PREFERRED EMBODIMENTS

The following is a description of an embodiment of a magnetostrictive torque sensor according to the present invention with reference to the accompanying drawings. The embodiment that is described below is in no way a limitation to the present invention.

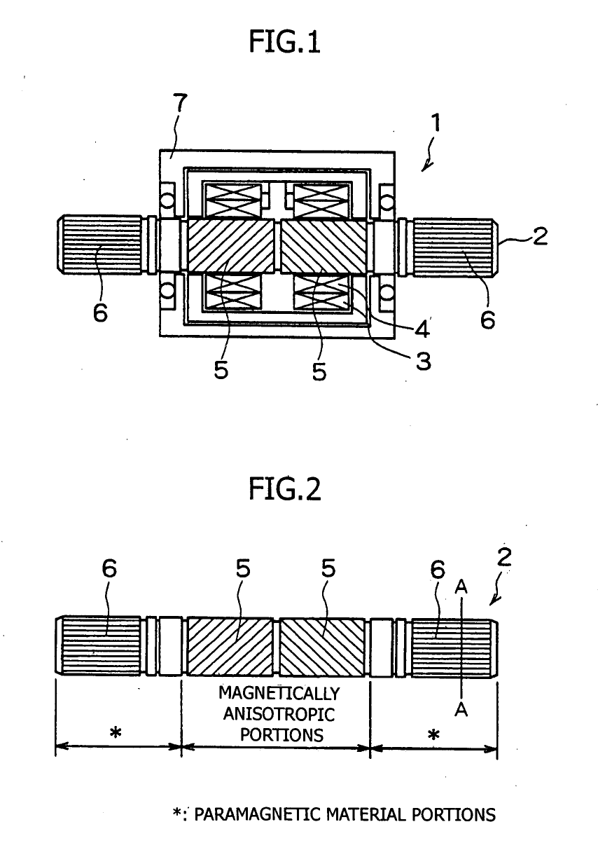

FIG. 1 is a schematic diagram of a magnetostrictive torque sensor according to the present invention. FIG. 2 is a schematic diagram of a torque sensor shaft according to the present invention.

As shown in FIGS. 1 and 2, main constituents of a magnetostrictive torque sensor 1 according to the present invention include a torque sensor shaft 2, an excitation solenoid coil 3, and a detection solenoid coil 4. The torque sensor shaft 2 is provided with magnetostrictive portions 5, the magnetic characteristics of which vary in response to stress (strain) and engaging portions 6 for connecting the torque sensor shaft 2 to other power transmission shafts (not shown in drawings).

The magnetostrictive portions 5 can be formed by being provided with grooves (not shown in drawings) that are tilted at approximately 45° with respect to the central axis of the torque sensor shaft 2 with predetermined spacing around the entire periphery of the torque sensor shaft 2. It should be noted that it is preferable that the torque sensor shaft 2 is provided with at least one pair of magnetostrictive portions 5 formed by grooves tilted in opposite directions with respect to the central axis of the torque sensor shaft 2.

In the configuration above, the magnetic permeability of the magnetostrictive portions 5, which are provided by the grooves with shape magnetic anisotropy, varies in response to stress. It should be noted that the angle of 45° with respect to the central axis is a direction where the stress in the tensile direction of the surface of the torque sensor shaft with respect to torsional load and the stress in the compression direction are maximal, and that the most effective detection of the stress in the tensile direction of the surface of the torque sensor shaft and stress in the compression direction can be achieved by forming the grooves in this direction.

It should also be noted that it is preferable to form portions of high magnetic permeability and to adjust magnetization properties as necessary by implementing induction hardening or shot peening at the grooved portions.

The excitation solenoid coil 3, which is an excitation means, is positioned so as to cover, and apply an alternating magnetic field to, the magnetostrictive portions 5. A detection means includes the detection solenoid coil 4 and electronic circuitry (not shown in drawings), and the detection solenoid coil 4 also is positioned so as to cover the magnetostrictive portions 5.

The excitation solenoid coil 3 makes the magnetic force lines along the magnetostrictive portions 5. As mentioned above, when stress is applied to the torque sensor shaft 2, the magnetic permeability of the magnetostrictive portions 5 changes, and such magnetic change can be detected by the detection solenoid coil 4.

It should be noted that the magnetostrictive portions 5, which are magnetically anisotropic portions of the torque sensor shaft 2, are accommodated with the excitation solenoid coil 3 and the detection solenoid coil 4 etc. inside a sensor case 7 made of aluminum that shields the effects of magnetization from external portions.

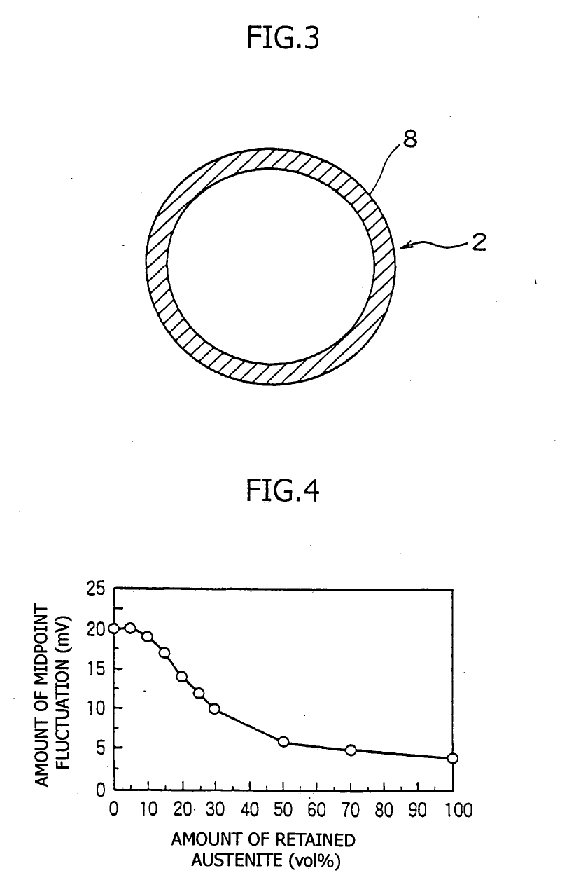

FIG. 3 is a schematic cross section of the torque sensor shaft at a line A in FIG. 2. As shown in FIG. 3, a paramagnetic layer 8 is provided in the engaging portions 6 that works to shield the magnetic force lines and contains retained austenite. The paramagnetic layer can be achieved by performing a carburization treatment on the torque sensor shaft 2, or at least the engaging portions 6 thereof but excluding the magnetostrictive detection portions, to form a layer containing retained austenite from the surface toward the inner portion. Since austenite, which has a face-centered cubic lattice, is paramagnetic, a magnetization shield can be achieved with this retained austenite.

By using structural steel, which is ferromagnetic, for the torque sensor shaft 2, it is possible to achieve the additional merit of using structural steel, which has good workability at a low price. Moreover, by using structural steel for the torque sensor shaft 2 itself, it is possible to achieve higher physical strength for the torque sensor shaft 2.

The area over which the paramagnetic layer 8 is provided includes at least the engaging portions 6 of the torque sensor shaft 2, and preferably includes portions that are not inside the sensor case 7. However, when the torque sensor shaft 2 itself is made of a ferromagnetic material, the magnetostrictive portions 5, which are magnetically anisotropic portions, should not be subjected to the carburization treatment, since the magnetostrictive properties of austenite are insufficient. For this reason, it is preferable that, at the time of the carburization treatment, an anti-carburization treatment is carried out on the magnetostrictive portions 5 and necessary treatments such as groove processing are carried out after the carburization treatment. The anti-carburization treatment can be achieved by carrying out a plating treatment with Cu or the like. It should be noted that Cu plating can be removed by a mechanical treatment or by acid.

FIG. 4 is a graph showing the relation between the amount of retained austenite and midpoint fluctuation. As shown in FIG. 4, a magnetization shield effect begins to become apparent and midpoint fluctuation decreases when the amount of retained austenite exceeds 10 vol %. In particular, the amount of midpoint fluctuation decreases particularly when the amount of retained austenite exceeds 50 vol %.

From this it is evident that, in the case of providing the paramagnetic layer using retained austenite, it is preferable that the amount of retained austenite is greater than 10 vol %, or more preferably at least 50 vol %. In the above-mentioned carburization treatment, it is preferable that various conditions such as carbon potential are set such that the amount of retained austenite is more than 10 vol %, or more preferably at least 50 vol %.

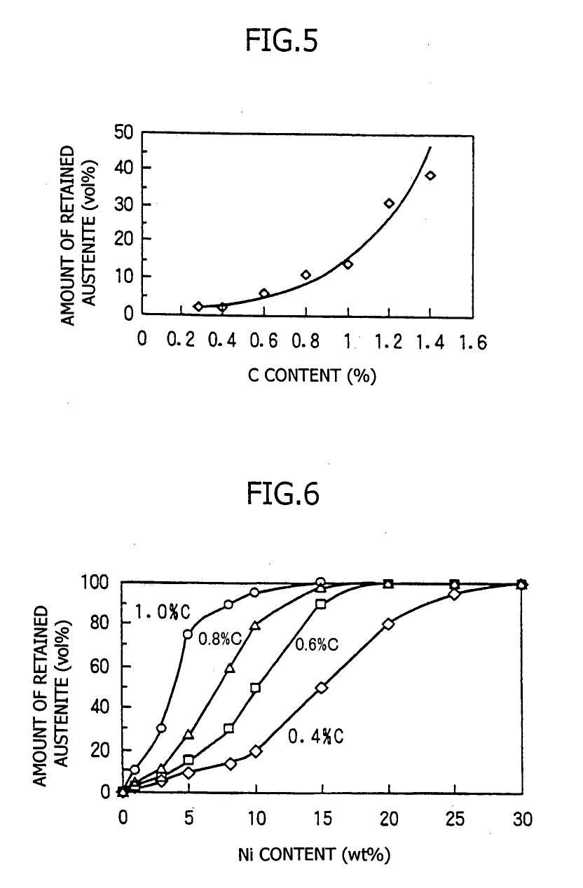

FIG. 5 is a graph showing the relation of the amount of retained austenite produced when Fe—C based alloys are quenched in water from the austenite range. The amount of retained austenite increases quadratically in relation to increases in the carbon content.

Furthermore, FIG. 6 is a graph showing the relation between the nickel content and the carbon content in steel and the amount of retained austenite produced when Fe—C—Ni based alloys are quenched in oil from the austenite range. Since nickel is an element that considerably decreases the Ms point (the starting temperature for martensitic transformation) and the Mf point (the finishing temperature for martensitic transformation), production of retained austenite can be considerably increased by having nickel present with carbon at the time of carburization. As shown in FIG. 6, the amount of retained austenite produced increases dramatically along with increases in the carbon content or increases in the nickel content due to interaction of these two elements when carbon and nickel are present together. In particular, it is possible to obtain a sufficient amount of retained austenite even with a small nickel content by increasing the carbon content.

As described above, it is preferable that the amount of retained austenite is at least 10 vol %, but by selecting an appropriate carbon content and nickel content in the ferromagnetic material used for the torque sensor shaft structure, it is possible to make the amount of retained austenite more than 10 vol % and to effectively suppress midpoint fluctuation. Specifically, it is preferable that the carbon potential due to carburization is at least 0.8 wt %, and at the same time that the nickel content in the ferromagnetic material used for the torque sensor shaft structure is at least 3 wt %. However, since the steel material itself becomes austenite steel when the nickel content exceeds 30 wt % and magnetostrictive properties cannot be obtained, the upper limit for the nickel content is 30 wt %.

As described above, it is possible to promote the production of retained austenite and to effectively suppress midpoint fluctuation when a ferromagnetic material that contains 3 wt % to 30 wt % nickel is used. For example, a steel containing nickel such as JIS SNCM815 or maraging steel or the like can be used as a ferromagnetic material, but there is no limitation to these. As described above, when nickel is added to steel, the amount of retained austenite produced at the time of the carburization treatment increases in relation to the amount of nickel. Moreover, the amount of retained austenite can be increased by increasing the carbon potential in the carburization treatment. Furthermore, the higher the quenching temperature, and the slower the cooling rate in the vicinity of the Ms point (the starting temperature for martensitic transformation), the greater the amount of retained austenite.

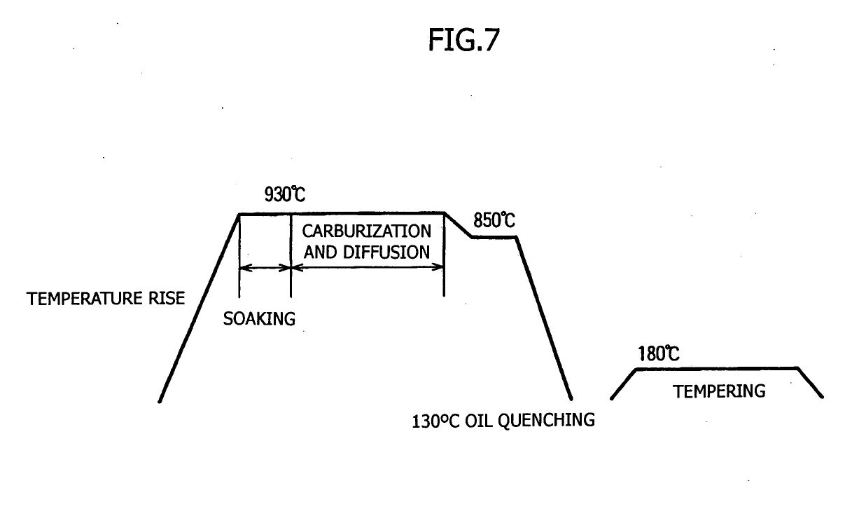

It should be noted that the carburization treatment can be achieved by the following process for example, which is shown schematically in FIG. 7. However, there is no limitation to this.

1. The torque sensor shaft 2 is inserted into a furnace and the temperature is raised to the range of 920° C. to 950° C. over a 1 to 2 hour period, and maintained for 30 to 60 minutes to carry out soaking.

2. A carburizing gas is introduced to the carburizing furnace such that the carbon potential in the furnace becomes from 1.0 to 1.2 wt %.

3. Carburization and diffusion are carried out by maintaining the temperature constant for 3 to 6 hours, and the amount of carbon from the surface of the shaft to a depth of 500 μm is made to be at least 0.8 wt %. Measurements with a sensor and control with a mixed gas are carried out so that the carbon potential at this time is kept in the range of 1.0 to 1.2 wt %.

4. The temperature is reduced to the range of 840° to 860° C., after which it is maintained for 10 to 30 minutes, then quenching is carried out by plunging the torque sensor shaft into oil of a temperature from 120° to 150° C.

5. Tempering is carried out by maintaining a temperature in the range of 150° to 200° C. for 2 to 4 hours.

It is preferable that the carburizing gas used here is a gas of a hydrocarbon such as methanol, propane, carbonic acid (H₂CO₃), methane (CH₄), and butane (C₄H₁₀) mixed with CO₂, CO, H₂, H₂O, NH₃, N₂, Ar, or the like.

It should be noted that the thickness of the paramagnetic layer 9 is preferably at least 300 μm and more preferably at least 500 μm. Generally, magnetic force lines of a high excitation frequency (approximately 40 Hz) are used in magnetostrictive solenoid coils. It is known that magnetic force lines of such a high excitation frequency penetrate only the surface layer (approximately 300 μm) of the sensor shaft. Accordingly, by providing a paramagnetic layer 9 of at least 300 μm using a carburization treatment, it is possible to form a sufficient magnetization shield layer.

### WORKING EXAMPLE

The following is a description of a working example according to the present invention.

Using a lathe, a rod-shaped structure of predetermined dimensions was formed from a round bar of JIS (Japanese Industrial Standards) SNCM815 alloy steel (composition shown in Table 1), which has a nickel content in the range of 4.00 to 4.50 wt %.

TABLE 1
Composition (wt %) of SNCM815

| C | Si | Mn | Ni | Cr | Mo | P | S | Cu |
|---|---|---|---|---|---|---|---|---|
| 0.14 | 0.26 | 0.41 | 4.07 | 0.77 | 0.15 | 0.09 | 0.007 | 0.08 |

Anti-carburization was carried out using Cu plating at positions in which magnetically anisotropic portions are formed. After rolling is performed at both ends to form serrations that will become part of the structure of the engaging portions, carburization quenching was performed as follows.

First, the torque sensor shaft was inserted into a furnace, then the temperature was raised to 930° C. and maintained at this temperature for 30 minutes to carry out soaking. Next, a gas in which methane, propane, and carbon gas are mixed was introduced to the carburizing furnace such that the carbon potential in the furnace became 1.2 wt %. Carburization and diffusion were carried out by keeping the temperature at 930° C. for 4 hours. A mixed gas was measured by carbon sensor and controlled so that the carbon potential at this time was constantly kept at 1.2 wt %. Next, the temperature was reduced to 850° C., after which it was maintained for 15 minutes, then quenching is carried out by plunging the torque sensor shaft into oil at a temperature of 130° C. Finally, tempering was carried out by maintaining a temperature of 180° C. for 2 hours.

With this carburization treatment, retained austenite was formed at a specific volume of at least 50% and a thickness of 500 μm from the surface.

Next, after removing the Cu plating on the anti-carburization portions with a mechanical process, opposing grooves (magnetically anisotropic portions) that are tilted at 45° with respect to the central axis were formed with a rolling process on the surface of the central portion. Shot peening was performed after high-frequency hardening was performed on the magnetically anisotropic portions to improve hysteresis and non-linearity. Conditions for shot peening included an arc height value of 0.25 mmA, and a grain size of 0.25 mm.

A torque sensor was configured by attaching to this torque sensor shaft a case made of aluminum containing solenoid coils and electrical circuitry. The specifications of this sensor are a rating of 10 N·m and output voltage of 1 V (0.1 V/N·m) at rated torque. As shown in Table 2, with regard to the fundamental properties of a torque sensor (output sensitivity, hysteresis, and non-linearity), a torque sensor shaft formed with a paramagnetic layer maintains properties that are not inferior compared to torque sensor shaft types without a paramagnetic layer.

TABLE 2
Relation between presence/absence of paramagnetic
material and torque sensor properties

| | | | | | | midpoint |
|---|---|---|---|---|---|---|
| | | | | | | voltage |
| | | | | | | fluctuation |
| | output | | | | | caused by |
| | sensi- | | | | | proximity |
| | tivity | hysteresis | | non-linearity | | to ferro- |
| | [mv/ | [% FS] | | [% FS] | | magnetic |
| | kgf · cm] | cw | ccw | cw | ccw | material |
| conven- | 11.4 | −0.6665 | −0.6862 | 0.3223 | −0.6194 | 20 mv |
| tional | | | | | | |
| type | | | | | | |
| magnet- | 11.4 | 0.5132 | 0.4993 | 0.4936 | −0.53 | 6 mv |
| ization | | | | | | |
| shield | | | | | | |
| using | | | | | | |
| retained | | | | | | |
| austenite | | | | | | |

Additionally, since a paramagnetic layer is formed using retained austenite on surface of the torque sensor shaft exposed from the case made of aluminum, midpoint fluctuation when the torque sensor shaft engages a steering shaft made of a ferromagnetic material structural alloy steel could be reduced from 20 mV to 6 mV. As a result, midpoint adjustments at the time of sensor engagement can be eliminated, and at the same time it is possible to optimize the amount of assistance from a motor that has highly sensitive torque detection, thus improving the feeling of handling operations. Furthermore, no reduction in sensor performance was evident even when an excessive torque of 150 N-m was applied, which is 15 times the rated torque.

1. A magnetostrictive torque sensor shaft comprising a magnetostrictive detection portion and an engaging portion for engaging a power transmission shaft, wherein the torque sensor shaft comprises a magnetostrictive material and comprises a paramagnetic layer having a content of retained austenite of at least 50 vol % at a surface of at least the engaging portion, but excluding the magnetostrictive detection portion.

2. (canceled)

3. The magnetostrictive torque sensor shaft according to claim 1, wherein a thickness of the paramagnetic layer is at least 300 μm.

4. The magnetostrictive torque sensor shaft according to claim 1, comprising a ferromagnetic material.

5. The magnetostrictive torque sensor shaft according to claim 4, wherein the ferromagnetic material contains 3 to 30 wt % Ni.

6. A magnetostrictive torque sensor comprising the magnetostrictive torque sensor shaft according to claim 1.

7. A method of manufacturing a magnetostrictive torque sensor shaft, the magnetostrictive torque sensor shaft comprising a magnetostrictive detection portion and an engaging portion for engaging a power transmission shaft, and containing 3 to 30 wt % Ni, comprising a step of carburization treatment on a surface of at least the engaging portion, but excluding the magnetostrictive detection portion of the torque sensor shaft, so as to form a paramagnetic layer containing retained austenite.

8. The method of manufacturing a magnetostrictive torque sensor shaft according to claim 7, wherein a carbon potential in the step of carburization treatment is at least 0.8 wt %.

9. The method of manufacturing a magnetostrictive torque sensor shaft according to claim 7, comprising, prior to the step of carburization treatment, a step of anti-carburization treatment on the magnetostrictive detection portion, and after the step of carburization treatment, a step of removing anti-carburization treated portion to expose a magnetostrictive material on a surface of the magnetostrictive detection portion.

10. The magnetostrictive torque sensor shaft according to claim 3, comprising a ferromagnetic material.

11. A magnetostrictive torque sensor comprising the magnetostrictive torque sensor shaft according to claim 3.

12. A magnetostrictive torque sensor comprising the magnetostrictive torque sensor shaft according to claim 4.

13. A magnetostrictive torque sensor comprising the magnetostrictive torque sensor shaft according to claim 5.

14. The method of manufacturing a magnetostrictive torque sensor shaft according to claim 8, comprising, prior to the step of carburization treatment, a step of anti-carburization treatment on the magnetostrictive detection portion, and after the step of carburization treatment, a step of removing anti-carburization treated portion to expose a magnetostrictive material on a surface of the magnetostrictive detection portion.
